(19) United States
(12) Patent Application Publication
(10) Pub. No.: US 2025/0051157 A1
(43) Pub. Date: Feb. 13, 2025

(54) HIGH PRESSURE NH3-REFORMING AND COMBINED REFORMING OF NH3 AS CO-FEED FOR HYDROCARBON/CO2-REFORMING

(71) Applicant: BASF SE, Ludwigshafen am Rhein (DE)

(72) Inventors: Elias Christopher FREI, Ludwigshafen am Rhein (DE); Michael KRAEMER, Ludwigshafen am Rhein (DE); Virginie LANVER, Ludwigshafen am Rhein (DE); Nils BOTTKE, Ludwigshafen am Rhein (DE)

(21) Appl. No.: 18/718,092

(22) PCT Filed: Dec. 14, 2022
(86) PCT No.: PCT/EP2022/085849

§ 371 Date: Jun. 10, 2024

(30) Foreign Application Priority Data
Dec. 15, 2021 (EP) 21214788.8

(51) Int. Cl. C01B 3/04; B01J 21/04; B01J 23/755; B01J 23/78; B01J 23/89; C01B 3/38

(52) U.S. Cl. CPC C01B 3/047; B01J 21/04; B01J 23/755; B01J 23/78; B01J 23/894; C01B 3/042; C01B 3/382; C01B 2203/0233; C01B 2203/0238; C01B 2203/1058

(57) ABSTRACT

The present invention relates to a specific process for the reforming of ammonia, wherein the process comprises
(i) providing a reactor containing a catalyst comprising a metal M1 selected from the group consisting of Ni, Co, or Ni and Co;
(ii) preparing a feed gas stream comprising NH₃;
(iii) feeding the feed gas stream prepared in (ii) into the reactor provided in (i) and contacting the feed gas stream with the catalyst, wherein contacting is performed at a pressure of 1 to 50 bara, and at a temperature of 400 to 1,100° C.;
(iv) removing an effluent gas stream from the reactor, the effluent gas stream comprising H₂ and N₂.

### TECHNICAL FIELD

The present invention relates to a process for the reforming of ammonia, and more specifi-cally to a process for the reforming of ammonia and hydrocarbons.

### INTRODUCTION

NH₃ is seen as an energy vector of the future, able to store chemically significant amounts of H₂. So, sustainable NH₃ might be produced on a large scale from regenerative energy sources. The reforming of NH₃ (see equation 1 below) on site, where the H₂ is needed, might be the last step in closing an H₂ value chain based on renewable electricity.

Thus, by way of example, Teramoto et al. in Int. J. of Hydr. and Energ., 2020, 45, 8965-8974 relates to the application of a combined NH₃ and CH₄ feed as part of a solid oxide fuel cell concept. Lu et al. in Int. J. of Hydr. and Energ., 2014, 39, 35, 19990-19999, on the other hand, reported on the hydrogen production by the dry reforming of CH₄ or NH₃ using an electric arc reactor for plasma creation.

WO 2021/175785 A1 concerns a steam purification step for eliminating amines and NH₃ prior to the reforming step.

WO 2013/068905 A and WO 2013/118078 A respectively relate to Ni and Co catalysts for the reforming of hydrocarbons with and without CO₂.

In Top. Catal. (2016) 59:1438-1457 the application Ni- and Co-based catalysts in NH₃-reforming is discussed, wherein the processes described therein are performed at low pressures <10 bara. With regard to NH₃-reforming at elevated pressures of >10 bara, Catal. Sci. Technol., 2020, 10, 5027-5035 discloses the use of a Ru-based catalyst.

To have direct access to H₂ at elevated pressure (10-50 bara), the NH₃-reforming itself must also be conducted at these pressures. Accordingly, there remains a need for and improved and cost-efficient process for NH₃-reforming which allows for the direct provision of H₂ under the conditions required for its further reaction.

### DETAILED DESCRIPTION

Thus, a process employing high temperature active (>500° C.) and very stable Ni- and Co-based catalysts, for the NH₃-reforming process approaching equilibrium conversion at high temperatures and pressures has surprisingly been found.

Traditionally, the reforming processes (see equations (1) to (5) below: steam reforming equation 2, dry reforming equation 3 and mixtures thereof as equation 4; autothermal reforming processes are not discussed) are applied to generate synthesis gas with a certain stoichiometric number (R═(H₂−CO₂)/(CO₂+CO)). With steam reforming, R values >2 are obtained, with dry reforming R values are <2. The reforming under dry conditions, where certain amounts of H₂O as steam are added to CO₂ and hydrocarbons (unspecific stoichiometry; see equation 4), results in R-values between steam and dry reforming (see equations 2 and 3). The reforming under dry conditions aims at a low steam to carbon ratio, to avoid, e.g., the coke formation and maximize the process efficiency.

Each process using synthesis gas needs a dedicated R-value. For the methanol synthesis, e.g., R-values between 2.0-2.3 are often applied. Within, e.g., a carbon capture and utilization (CCU) concept the dry reforming and reforming under dry conditions are processes, where significant amounts of CO₂ are used. When CH₄ (representative for hydrocarbons) is, e.g., from biogenic sources, a sustainable syngas is created.

It has unexpectedly been found that some catalysts which perform very well under the reforming conditions described in equations (2)-(4), are also capable of NH₃-reforming. Since the reforming of NH₃ delivers directly the H₂ that is needed to adjust the R-value to a specific value, a combined reforming of NH₃ as co-feed to the reforming of hydrocarbons with or without CO₂ has surprisingly been found. Equation (5) shows, here in a stoichiometric unspecific way, the exemplified application of a combined reforming process using ideally one and the same reactor.

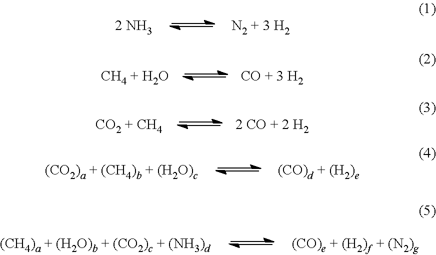

Thus, in summary, the endothermic NH₃-reforming (equation1) is conducted in a broad pressure range (1-50 bara), in particular at elevated pressures (10-50 bara), and temperatures (400-1100° C., in particular 500-980° C.) to obtain H₂ as part of a sustainable H₂ value-chain. The corresponding processes and catalysts have been developed. Since the reforming processes (e.g. CH₄/CO₂/H₂O) follows the same temperature and pressure conditions, and the Ni- and Co-based catalysts are identical, a combined reforming process of NH₃ and reforming of, e.g., hydrocarbons/CO₂/H₂O is further provided (see equation 5 as general).

It was therefore the object of the present invention to provide an improved catalytic process conducted in a broad pressure range (1-50 bara), in particular at elevated pressure (10-50 bara), which is able to reform NH₃ to create H₂. The NH₃-reforming is either applied as single reaction/feed or in combination with a reforming of hydrocarbons. If the combined reforming is applied, NH₃ is dosed as co-feed to a gas mixture for, e.g., the reforming under dry conditions comprising hydrocarbons, CO₂, and H₂O

Ni-based catalysts applied in the reforming of NH₃ have been identified which are already active at comparably low temperatures <400° C. Other catalysts have been identified which are active at elevated temperatures >450° C. It has unexpectedly been found that the high temperature active catalysts are also suitable for the combined reforming approach of NH₃ and hydrocarbons.

Thus, Co- and Ni-based catalysts have been identified, which are applied in the reforming of hydrocarbons, and which surprisingly perform also very well in the NH₃-reforming. This serves as an enabler for a combined reforming approach, where the same catalyst can pro-duce a synthesis gas, which matches the R-value of the corresponding down-stream application (e.g. MeOH production, DME production or Fischer-Tropsch process).

Accordingly, it has quite unexpectedly been found that these catalysts are applicable in any constellation of NH₃-reforming alone, or NH₃ as co-feed for the reforming of hydrocarbons with or without CO₂ in any quantity of NH₃ dosing.

The idea of, e.g., the methanol formation from the hydrogenation of CO₂ within a carbon capture and utilization (CCU) concept strongly relies on the hydrogen supply. Generally, the hydrogen is provided by H₂O-electrolysis. Within a sustainable and green methanol concept, the electricity for the electrolysis should be created in a regenerative fashion. The drawback of a regenerative source of electricity is its non-static character (wind or solar). As a conse-quence of the fluctuating sources, also the electrolysis and the down-stream application, e.g. methanol synthesis, has to be operated dynamically (specific on-off scenarios). A coupled approach of the CO₂ to methanol technology and the combined reforming of NH₃ and hydrocarbons (e.g. CH₄)/CO₂ under, e.g., dry conditions, as described in the present application, might deliver more H₂ when the electrolysis is delivering less. This is simply realized upon increasing the NH₃ co-dosing within the combined reforming approach. This concept is in principle adaptable to any syngas related processes including H₂O electrolysis coupled with the combined reforming described in the present application.

Therefore, the present invention relates to a process for the reforming of ammonia, wherein the process comprises
(i) providing a reactor containing a catalyst comprising a metal M1 selected from the group consisting of Ni, Co, or Ni and Co;
(ii) preparing a feed gas stream comprising NH₃;
(iii) feeding the feed gas stream prepared in (ii) into the reactor provided in (i) and contacting the feed gas stream with the catalyst, wherein contacting is performed at a pressure of 1 to 50 bara, and at a temperature of 400 to 1,100° C.;
(iv) removing an effluent gas stream from the reactor, the effluent gas stream comprising H₂ and N₂.

It is preferred that contacting is performed at a pressure in the range of from 5 to 50 bara, more preferably from 10 to 50 bara, more preferably of from 15 to 45 bara, more preferably of from 15 to 40 bara, more preferably of from 18 to 35 bara, more preferably of from 20 to 28 bara, and more preferably of from 20 to 25 bara.

It is preferred that contacting is performed at a temperature in the range of from 450 to 1,000° C., more preferably of from 475 to 975° C., more preferably of from 500 to 900° C., more preferably of from 550 to 800° C., more preferably of from 600 to 750° C., and more preferably of from 650 to 700° C.

It is preferred that the feed gas stream prepared in (ii) comprises from 1 to 100 vol.-% of NH₃, more preferably from 3 to 99.99 vol.-%, more preferably from 5 to 99.95 vol.-%, more preferably from 10 to 99.9 vol.-%, more preferably from 12 to 99.9 vol.-%, more preferably from 20 to 99.8 vol.-%, more preferably from 22 to 99.8 vol.-%, more preferably from 30 to 99.7 vol.-%, more preferably from 40 to 99.6 vol.-%, and more preferably from 50 to 99.5 vol.-%.

It is preferred that the feed gas stream prepared in (ii) comprises from 0 to 50 vol.-% of N₂, more preferably from 0.01 to 30 vol.-%, more preferably from 0.02 to 25 vol.-%, more preferably from 0.03 to 15 vol.-%, more preferably from 0.04 to 10 vol.-%, more preferably from 0.05 to 5 vol.-%, more preferably from 0.1 to 1 vol.-%, more preferably from 0.12 to 0.5 vol.-%, and more preferably from 0.14 to 0.16 vol.-%.

It is preferred that the feed gas stream prepared in (ii) comprises from 0 to 75 vol.-% of H₂, more preferably from 0 to 60 vol.-%, more preferably from 0 to 50 vol.-%, more preferably from 0 to 40 vol.-%, more preferably from 0 to 35 vol.-%, and more preferably from 0 to 30 vol.-%.

It is preferred that the feed gas stream prepared in (ii) comprises from 200 to 20,000 ppmv of H₂O, more preferably from 500 to 15,000 ppmv, more preferably from 800 to 10,000 ppmv, and more preferably from 1,000 to 5,000 ppmv.

It is preferred that the total amount of NH₃, N₂, and H₂ comprised in the feed gas stream prepared in (ii) is in the range from 90 to 100 wt.-%, more preferably from 95 to 99.95 vol.-%, more preferably from 98 to 99.9 vol.-%, more preferably from 99 to 99.85 vol.-%, and more preferably from 99.7 to 99.8 vol.-%.

It is preferred that the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO.

In case where the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO, it is preferred that the feed gas stream prepared in (ii) further comprises CO₂ and one or more hydrocarbons, wherein more preferably the feed gas stream comprises 5 vol.-% or less of H₂O, more preferably 3 vol.-% or less, more preferably 1 vol.-% or less, more preferably 0.5 vol.-% or less, more preferably 0.1 vol.-% or less, more preferably 0.05 vol.-% or less, and more preferably 0.01 vol.-% or less of H₂O. Furthermore and independently thereof, it is preferred that the feed gas stream prepared in (ii) further comprises H₂O, and one or more hydrocarbons, wherein more preferably the feed gas stream comprises 5 vol.-% or less of CO₂, more preferably 3 vol.-% or less, more preferably 1 vol.-% or less, more preferably 0.5 vol.-% or less, more preferably 0.1 vol.-% or less, more preferably 0.05 vol.-% or less, and more preferably 0.01 vol.-% or less of CO₂. Furthermore and independently thereof, it is preferred that the feed gas stream prepared in (ii) further comprises CO₂, H₂O, and one or more hydrocarbons.

Where the process is for the reforming of ammonia and hydrocarbons, it is further preferred that the one or more hydrocarbons are selected from the group consisting of alkanes and mixtures thereof, more preferably of C1-C10 alkanes and mixtures thereof, more preferably of C3-C9 alkanes and mixtures thereof, more preferably of C4-C8 alkanes and mixtures thereof, more preferably of C5-C7 alkanes and mixtures thereof, more preferably of C6 alkanes and mixtures thereof. Furthermore and independently thereof, it is preferred that contacting is performed at a pressure in the range of from 10 to 50 bara, more preferably of from 12 to 45 bara, more preferably of from 15 to 40 bara., more preferably of from 18 to 35 bara, and more preferably of from 20 to 30 bara. Furthermore and independently thereof, it is preferred that the feed gas stream prepared in (ii) comprises from 0.1 to 75 vol.-% of NH₃, more preferably from 0.3 to 60 vol.-%, more preferably from 0.5 to 50 vol.-%, more preferably from 0.8 to 40 vol.-%, more preferably from 1 to 30 vol.-%, more preferably from 12 to 25 vol.-%. Furthermore and independently thereof, it is preferred that the feed gas stream prepared in (ii) comprises from 10 to 70 vol.-% of the one or more hydrocarbons, more preferably from 12 to 60 vol.-%, more preferably from 15 to 50 vol.-%, more preferably from 20 to 40 vol.-%, more preferably from 22 to 29 vol.-%. Furthermore and independently thereof, it is preferred that the feed gas stream prepared in (ii) comprises from 0 to 75 vol.-% of H₂₀, more preferably from 0.5 to 70 vol.-%, more preferably from 1 to 68 vol.-%, more preferably from 3 to 66 vol.-%, more preferably from 5 to 64 vol.-%, more preferably from 8 to 62 vol.-%, more preferably from 10 to 60 vol.-%, more preferably from 25 to 50 vol.-%, more preferably from 33 to 44 vol.-%. Furthermore and independently thereof, it is preferred that the feed gas stream prepared in (ii) comprises from 0 to 60 vol.-% of CO₂, more preferably from 1 to 58 vol.-%, more preferably from 3 to 56 vol.-%, more preferably from 5 to 54 vol.-%, more preferably from 8 to 52 vol.-%, more preferably from 10 to 50 vol.-%, more preferably from 12 to 20 vol.-%. Furthermore and independently thereof, it is preferred that the feed stream displays an H₂O:C molar ratio of H₂O to carbon contained in the one or more hydrocarbons in the range of from 0 to 4, more preferably of from 0.1 to 3, more preferably of from 0.3 to 2.5, more preferably of from 0.4 to 2, and more preferably of from 0.5 to 1.6.

In case where the feed stream displays an H₂O:C molar ratio of H₂O to carbon contained in the one or more hydrocarbons in the range of from 0 to 4, it is preferred that the catalyst comprises Ni, wherein the feed stream displays an H₂O:C molar ratio of H₂O to carbon contained in the one or more hydrocarbons in the range of from 0.6 to 3, more preferably of from 0.7 to 2.5, more preferably of from 0.8 to 2, and more preferably of from 0.9 to 1.6. Furthermore, and independently thereof, it is preferred that the catalyst comprises Co, wherein the feed stream displays an H₂O:C molar ratio of H₂O to carbon contained in the one or more hydrocarbons in the range of from 0.2 to 2.5, more preferably of from 0.3 to 2, more preferably of from 0.4 to 1.8, and more preferably of from 0.5 to 1.5.

Where the process is for the reforming of ammonia and hydrocarbons, it is further preferred that the feed stream displays a CO₂:C molar ratio of CO₂ to carbon contained in the one or more hydrocarbons in the range of from 0 to 4, more preferably of from 0.1 to 3, more preferably of from 0.2 to 2, more preferably of from 0.3 to 1.5, more preferably of from 0.4 to 0.8. Furthermore and independently thereof, it is preferred that the feed stream displays an NH₃: C molar ratio of NH₃ to carbon contained in the one or more hydrocarbons in the range of from 0 to 5, more preferably of from 0 to 4, more preferably of from 0.001 to 3, more preferably of from 0.005 to 2, and more preferably of from 0.01 to 1.

According to the present invention, it is preferred that the feed stream is fed into the reactor at a gas hourly space velocity in the range of from 500 to 16,000 h⁻¹, more preferably of from 700 to 14,000 h⁻¹, more preferably of from 800 to 12,000 h⁻¹, more preferably of from 900 to 10,000 h⁻¹, more preferably of from 950 to 8,500 h⁻¹, and more preferably of from 1,000 to 8,000 h⁻¹.

Where the process is for the reforming of ammonia and hydrocarbons, itis preferred that the effluent gas stream removed in (iv) further comprises CO₂.

Furthermore and independently thereof, where the process is for the reforming of ammonia and hydrocarbons, it is further preferred that the effluent gas stream removed in (iv) displays a stoichiometry number R in the range of from 0.1 to 3, wherein R is defined according to formula (I):

$$R = \frac{c ( {H}_{2} ) - c ( {CO}_{2} )}{c ( {CO}_{2} ) + c ( CO )} , \qquad ( I )$$

wherein c(H₂), c(CO₂), and c(CO) stand for the molar concentration of H₂, CO₂, and CO in the effluent gas stream, respectively.

In case where the effluent gas stream removed in (iv) displays a stoichiometry number R, it is preferred that the stoichiometry number R is in the range of from 1 to 2.5, more preferably of from 1.3 to 2.2.

Furthermore and independently thereof, it is preferred that R>2.

Independently thereof, it is preferred that the effluent gas stream removed in (iv) displays an H₂: CO molar ratio of >2.

In case where the effluent gas stream removed in (iv) displays a stoichiometry number R, it is preferred that the stoichiometry number R is in the range of 0.5 to 3, more preferably of from 1 to 2.2, and more preferably of 1.3 to 1.7.

Where the process is for the reforming of ammonia and hydrocarbons, it is further preferred that the effluent gas stream removed in (iv) comprises from 10 to 90 vol.-% of H₂, more preferably from 20 to 80 vol.-%, more preferably from 30 to 70 vol.-%, more preferably from to 65 vol.-%, and more preferably from 45 to 60 vol.-%. Furthermore and independently thereof, itis preferred that the effluent gas stream removed in (iv) comprises from 1 to 70 vol.-% of CO, more preferably from 3 to 50 vol.-%, more preferably from 5 to 40 vol.-%, more preferably from 10 to 35 vol.-%, and more preferably from 15 to 30 vol.-%. Furthermore and independently thereof, itthe effluent gas stream removed in (iv) comprises from 1 to 50 vol.-% of CO₂, more preferably from 3 to 45 vol.-%, more preferably from 5 to 40 vol.-%, more preferably from 8 to 35 vol.-%, more preferably from 10 to 30 vol.-%, and more preferably from 12 to 25 vol.-%.

According to the present invention, it is preferred that the effluent gas stream removed in (iv) is employed in a process for the production of methanol, for the production of dimethyl ether, or for the production of methanol and dimethylether.

It is preferred that the effluent gas stream removed in (iv) is employed in a process for the production of hydrocarbons, more preferably according to the Fischer-Tropsch process.

It is preferred that the effluent gas stream removed in (iv) is employed in a process for the production of alcohols, more preferably of alkanols, more preferably of C1 to C10 alkanols, more preferably of C₂ to C₈ alkanols, more preferably of C₂ to C₆ alkanols, more preferably of C₂ to C₄ alkanols, more preferably of C2 alkanols, and more preferably of ethanol.

It is preferred that after (i) and prior to (iii) the catalyst contained in the reactor provided in (i) is reduced in an atmosphere comprising hydrogen.

In case where after (i) and prior to (iii) the catalyst contained in the reactor provided in (i) is reduced in an atmosphere comprising hydrogen, it is preferred that the reduction is conducted at a temperature in the range of from 450 to 980° C., more preferably of from 500 to 950° C., more preferably of from 600 to 920° C., more preferably of from 700 to 890° C., more preferably of from 750 to 870° C., and more preferably of from 800 to 850° C. Furthermore and independently thereof, it is preferred that the reduction is conducted in an atmosphere comprising from 1 to 99 vol.-% H₂, more preferably from 3 to 90 vol.-%, more preferably from 5 to 80 vol.-%, more preferably from 6 to 50 vol.-%, more preferably from 7 to 30 vol.-%, more preferably from 8 to 20 vol.-%, and more preferably from 9 to 15 vol-%. Furthermore and independently thereof, it is preferred that the atmosphere comprises from 1 to 99 vol.-% of an inert gas, more preferably of from 5 to 95 vol.-%, more preferably of from 10 to 90 vol.-%, more preferably from 30 to 70 vol.-%, and more preferably from 45 to 55 vol.-%. Furthermore and independently thereof, it is preferred that the inert gas comprises one or more gases selected from the group consisting of noble gases and nitrogen gas, more preferably from the group consisting of He, Ar, Ne, and N₂, wherein more preferably the inert gas comprises Ar, N₂, or Ar and N₂, wherein more preferably the inert gas comprises N₂, wherein more preferably the inert gas is N₂.

According to the present invention, it is preferred that at an initial stage of the process, the feed gas stream prepared in (ii) and fed into the reactor in (iii) further comprises H₂ for reducing the catalyst.

In case where at an initial stage of the process the feed gas stream prepared in (ii) and fed into the reactor in (iii) further comprises H₂ for reducing the catalyst, it is preferred that the feed gas stream further comprises from 2 to 80 vol.-% of H₂, more preferably from 5 to 70 vol.-%, more preferably from 10 to 60 vol.-%, more preferably from 20 to 50 vol.-%, more preferably from 30 to 40 vol.-%.

According to the present invention it is preferred that the catalyst contained in the reactor provided in (i) further comprises a metal M2 selected from the group consisting of alkali metals, alkaline earth metals, Mo, Fe, and Ru, including mixtures of two or more thereof, more preferably from the group consisting of Li, K, Na, Cs, Mg, Ca, Sr, Ba, Mo, Fe, and Ru, including mixtures of two or more thereof, more preferably from the group consisting of K, Na, Cs, Ba, Mo, Fe, and Ru, including mixtures of two or more thereof, more preferably from the group consisting of K, Ba, Mo, Fe, and Ru, including mixtures of two or more thereof, more preferably from the group consisting of Fe, Ru, or Fe and Ru, wherein preferably M2 comprises Ru, wherein more preferably M2 is Ru.

It is preferred that the catalyst contained in the reactor provided in (i) further comprises one or more support materials onto which the metal M1 or the metals M1 and M2 are supported, wherein the one or more support materials are preferably selected from the group consisting of Al₂O₃, SiO₂, ZrO₂, CeO₂, MgO, CaO, and mixtures of two or more thereof, more preferably from the group consisting of Al₂O₃, SiO₂, ZrO₂, CeO₂, and mixtures of two or more thereof, more preferably from the group consisting of Al₂O₃, SiO₂, and mixtures thereof, wherein more preferably the support material comprises Al₂O₃. Furthermore and independently thereof, it is preferred that the catalyst contained in the reactor provided in (i) displays an M2: M1 atomic ratio in the range of from 0.1:99.9 to 80:20, more preferably of from 0.5:99.5 to 75:25, more preferably of from 1:99 to 70:30, more preferably of from 5:95 to 65:35, more preferably of from 15:85 to 60:40, more preferably of from 30:70 to 55:45, and more preferably of from 40:60 to 50:50.

In case where the catalyst contained in the reactor provided in (i) displays a specific M2: M1 atomic ratio, it is preferred that M2 comprises, preferably is, Fe, and wherein the catalyst displays an M2: M1 atomic ratio in the range of from 1:99 to 80:20, more preferably of from 5:95 to 75:25, more preferably of from 10:90 to 70:30, more preferably of from 20:80 to 65:35, more preferably of from 30:70 to 60:40, more preferably of from 35:65 to 55:45, and more preferably of from 40:60 to 50:50. Furthermore and independently thereof, it is preferred that M2 comprises, preferably is, Ru, and wherein the catalyst displays an M2: M1 atomic ratio in the range of from 0.1:99.9 to 30:70, more preferably of from 0.5:99.5 to 30:70, more preferably of from 1:99 to 20:80, more preferably of from 3:97 to 10:90, and more preferably of from 5:95 to 6:94.

According to the present invention it is preferred that the catalyst contained in the reactor provided in (i) further comprises Al and O.

In case where the catalyst contained in the reactor provided in (i) further comprises Al and O, it is preferred that the catalyst comprises Ni as the metal M1, wherein preferably the metal M1 is Ni.

In case where the catalyst contained in the reactor provided in (i) comprises Ni as the metal M1, it is preferred that the catalyst further comprises Mg, wherein the Ni: Mg: Al molar ratio is preferably in the range of from 1:(0.1-12):(0.5-20), more preferably of from 1: (0.5-8):(1-12), more preferably of from 1:(1-5):(3-8), more preferably of from 1: (1.5-3):(3.5-5), and more preferably of from 1:(2.0-2.4):(4.0-4.4). Furthermore and independently thereof, it is preferred that from 95 to 100 wt.-% of the catalyst consists of Ni, Mg, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%. Furthermore and independently thereof, it is preferred that from 95 to 100 wt.-% of the catalyst consists of M2, Ni, Mg, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

In case where the catalyst contained in the reactor provided in (i) further comprises Al and O, it is preferred that the catalyst comprises Co as the metal M1, wherein more preferably the metal M1 is Co.

In case where the catalyst contained in the reactor provided in (i) comprises Co as the metal M1, it is preferred that the catalyst further comprises La, wherein the Co:La:Al molar ratio is preferably in the range of from 1:(0.1-8):(1-50), more preferably of from 1: (0.5-5):(3-30), more preferably of from 1: (0.8-3):(5-20), more preferably of from 1: (1-2):(8-15), and more preferably of from 1: (1.3-1.7):(10-12). Furthermore and independently thereof, it is preferred that from 95 to 100 wt.-% of the catalyst consists of Co, La, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%. Furthermore and independently thereof, it is preferred that from 95 to 100 wt.-% of the catalyst consists of M2, Co, La, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

It is preferred that the catalyst contained in the reactor provided in (i) is in form of a molding, and it is further preferred that the molding is a tablet.

In the case where the catalyst is a tablet, it is preferred according to a first alternative that the tablet has a four-hole cross-section, more preferably a four-hole cross-section having a diameter in the range of from 12 to 19 mm, more preferably in the range of from 16 to 18 mm, more preferably in the range of from 16.7 to 16.8 mm, and a height in the range of from 7 to 11 mm, more preferably in the range of from 9.5 to 10.5 mm, more preferably in the range of from 9.7 to 10.0 mm. It is preferred that the tablet is a calcined tablet, wherein the calcination has more preferably been performed in a gas atmosphere having a temperature in the range of from 350 to 450° C., more preferably in the range of from 360 to 440° C., more preferably in the range of from 375 to 425° C., more preferably in the range of from 390 to 410° C., wherein the gas atmosphere more preferably comprised oxygen, more preferably was one or more of oxygen, air, or lean air, wherein the calcining was performed more preferably for 0.5 to 20, more preferably for 1 to 15 h, more preferably for 2 to 10 h, more preferably for 3 to 5 h. It is preferred that the tablet has a side crushing strength 1 (SCS1) of at least 70 N, more preferably in the range of from 70 to 250 N, more preferably in the range of from 70 to 130 N, determined as described in Reference Example 2, wherein four cylindrical segments are located in an area each between two flutes, wherein the side crushing strength 1 is measured according to Reference Example 2 in a condition where the tablet stands on two cylindrical segments sided by a flute. It is preferred that the tablet has a side crushing strength 2 (SCS2) of at least 60 N, more preferably in the range of from 60 to 200 N, more preferably in the range of from 60 to 88 N, determined as described in Reference Example 2, wherein four cylindrical segments are located in an area each between two flutes, wherein the side crushing strength 2 is measured according to Reference Example 2 in a condition where the tablet stands on a cylindrical segment. It is preferred that the tablet has a side crushing strength 3 (SCS3) of at least 190 N, preferably in the range of from 190 to 350 N, more preferably in the range of from 190 to 240 N, determined as described in Reference Example 2, wherein four cylindrical segments are located in an area each between two flutes, wherein the side crushing strength 3 is measured according to Reference Example 2 in a condition where the area of the cylindrical segments is perpendicular to the direction of the force applied on the tablet.

Further in the case where the catalyst is a tablet, it is preferred according to a second alternative that the tablet has a four-hole cross-section, more preferably a four-hole cross-section having a diameter in the range of from 10 to 18 mm, more preferably in the range of from 13.5 to 16.0 mm, more preferably in the range of from 14.0 to 15.5 mm, and a height in the range of from 5 to 11 mm, more preferably in the range of from 7.5 to 9.4 mm, more preferably in the range of from 8.2 to 9.0 mm. It is preferred that the tablet is a calcined tablet, wherein the calcination has more preferably been performed in a gas atmosphere having a temperature in the range of from 800 to 1400° C., more preferably in the range of from 875 to 1275° C., more preferably in the range of from 950 to 1250° C., more preferably in the range of from 1050 to 1225° C., wherein the gas atmosphere more preferably comprised oxygen, more preferably was one or more of oxygen, air, or lean air, wherein the calcining was performed more preferably for 0.5 to 20 h, more preferably for 1 to 15 h, more preferably for 2 to 10 h, more preferably for 3 to 5 h. It is preferred that the tablet has a side crushing strength 1 (SCS1) of at least 366 N, more preferably of at least 400 N, more preferably in the range of from 400 to 800 N, more preferably in the range of from 400 to 600 N, more preferably in the range of from 400 to 570 N, determined as described in Reference Example 1, the molding more preferably being a tablet having a four-hole cross-section and having four flutes, wherein four cylindrical segments are located in an area each between two flutes, wherein the side crushing strength 1 is measured according to Reference Example 1 in a condition where the tablet stands on two cylindrical segments sided by a flute. It is preferred that the tablet has a side crushing strength 2 (SCS2) of at least 170 N, more preferably of at least 190 N, more preferably in the range of from 190 to 450 N, more preferably in the range of from 190 to 300 N, more preferably in the range of from 190 to 270 N, deter-mined as described in Reference Example 1, wherein four cylindrical segments are located in an area each between two flutes, wherein the side crushing strength 2 is measured according to Reference Example 1 in a condition where the tablet stands on a cylindrical segment. It is preferred that the tablet has a side crushing strength 3 (SCS3) of at least 345 N, more preferably of at least 500 N, more preferably in the range of from 500 to 950 N, more preferably in the range of from 500 to 800 N, more preferably in the range of from 500 to 770 N, determined as described in Reference Example 1, wherein four cylindrical segments are located in an area each between two flutes, wherein the side crushing strength 3 is preferably measured according to Reference Example 1 in a condition where the area of the cylindrical segments is perpendicular to the direction of the force applied on the tablet.

The present invention is further illustrated by the following set of embodiments and combi-nations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”. Further, it is explicitly noted that the following set of embodiments is not the set of claims determining the extent of protec-tion, but represents a suitably structured part of the description directed to general and preferred aspects of the present invention.

1. A process for the reforming of ammonia, wherein the process comprises
(i) providing a reactor containing a catalyst comprising a metal M1 selected from the group consisting of Ni, Co, or Ni and Co;
(ii) preparing a feed gas stream comprising NH₃;
(iii) feeding the feed gas stream prepared in (ii) into the reactor provided in (i) and contacting the feed gas stream with the catalyst, wherein contacting is performed at a pressure of 1 to 50 bara, and at a temperature of 400 to 1,100° C.;
(iv) removing an effluent gas stream from the reactor, the effluent gas stream com-prising H₂ and N₂.

2. The process of embodiment 1, wherein contacting is performed at a pressure in the range of from 5 to 50 bara, preferably from 10 to 50 bara, more preferably of from 15 to 45 bara, preferably of from 15 to 40 bara, more preferably of from 18 to 35 bara, more preferably of from 20 to 28 bara, and more preferably of from 20 to 25 bara.

3. The process of embodiment 1 or 2, wherein contacting is performed at a temperature in the range of from 450 to 1,000° C., preferably of from 475 to 975° C., more preferably of from 500 to 900° C., more preferably of from 550 to 800° C., more preferably of from 600 to 750° C., and more preferably of from 650 to 700° C.

4. The process of any of embodiments 1 to 3, wherein the feed gas stream prepared in (ii) comprises from 1 to 100 vol.-% of NH₃, preferably from 3 to 99.99 vol.-%, more preferably from 5 to 99.95 vol.-%, more preferably from 10 to 99.9 vol.-%, more preferably from 12 to 99.9 vol.-%, more preferably from 20 to 99.8 vol.-%, more preferably from 22 to 99.8 vol.-%, more preferably from 30 to 99.7 vol.-%, more preferably from 40 to 99.6 vol.-%, and more preferably from 50 to 99.5 vol.-%.

5. The process of any of embodiments 1 to 4, wherein the feed gas stream prepared in (ii) comprises from 0 to 50 vol.-% of N₂, preferably from 0.01 to 30 vol.-%, more preferably from 0.02 to 25 vol.-%, more preferably from 0.03 to 15 vol.-%, more preferably from 0.04 to 10 vol.-%, more preferably from 0.05 to 5 vol.-%, more preferably from 0.1 to 1 vol.-%, more preferably from 0.12 to 0.5 vol.-%, and more preferably from 0.14 to 0.16 vol.-%.

6. The process of any of embodiments 1 to 5, wherein the feed gas stream prepared in (ii) comprises from 0 to 75 vol.-% of H₂, preferably from 0 to 60 vol.-%, more preferably from 0 to 50 vol.-%, more preferably from 0 to 40 vol.-%, more preferably from 0 to 35 vol.-%, and more preferably from 0 to 30 vol.-%.

7. The process of any of embodiments 1 to 6, wherein the feed gas stream prepared in (ii) comprises from 200 to 20,000 ppmv of H₂O, preferably from 500 to 15,000 ppmv, more preferably from 800 to 10,000 ppmv, and more preferably from 1,000 to 5,000 ppmv.

8. The process of any of embodiments 1 to 7, wherein the total amount of NH₃, N₂, and H₂ comprised in the feed gas stream prepared in (ii) is in the range from 90 to 100 wt.-%, preferably from 95 to 99.95 vol.-%, more preferably from 98 to 99.9 vol.-%, more preferably from 99 to 99.85 vol.-%, and more preferably from 99.7 to 99.8 vol.-%.

9. The process of any of embodiments 1 to 8, wherein the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO.

10. The process of embodiment 9, wherein the feed gas stream prepared in (ii) further comprises CO₂ and one or more hydrocarbons, and wherein the feed gas stream preferably comprises 5 vol.-% or less of H₂O, more preferably 3 vol.-% or less, more preferably 1 vol.-% or less, more preferably 0.5 vol.-% or less, more preferably 0.1 vol.-% or less, more preferably 0.05 vol.-% or less, and more preferably 0.01 vol.-% or less of H₂O.

11. The process of embodiment 9, wherein the feed gas stream prepared in (ii) further comprises H₂O, and one or more hydrocarbons, and wherein the feed gas stream preferably comprises 5 vol.-% or less of CO₂, more preferably 3 vol.-% or less, more preferably 1 vol.-% or less, more preferably 0.5 vol.-% or less, more preferably 0.1 vol.-% or less, more preferably 0.05 vol.-% or less, and more preferably 0.01 vol.-% or less of CO₂.

12. The process of embodiment 9, wherein the feed gas stream prepared in (ii) further comprises CO₂, H₂O, and one or more hydrocarbons.

13. The process of any of embodiments 9 to 12, wherein the one or more hydrocarbons are selected from the group consisting of alkanes and mixtures thereof, preferably of C1-C10 alkanes and mixtures thereof, more preferably of C3-C9 alkanes and mixtures thereof, more preferably of C4-C8 alkanes and mixtures thereof, more preferably of C5-C7 alkanes and mixtures thereof, more preferably of C6 alkanes and mixtures thereof.

14. The process of any of embodiments 9 to 13, wherein contacting is performed at a pressure in the range of from 10 to 50 bara, preferably of from 12 to 45 bara, more preferably of from 15 to 40 bara, more preferably of from 18 to 35 bara, and more preferably of from 20 to 30 bara.

15. The process of any of embodiments 9 to 14, wherein the feed gas stream prepared in (ii) comprises from 0.1 to 75 vol.-% of NH₃, preferably from 0.3 to 60 vol.-%, more preferably from 0.5 to 50 vol.-%, more preferably from 0.8 to 40 vol.-%, more preferably from 1 to 30 vol.-%, more preferably from 12 to 25 vol.-%.

16. The process of any of embodiments 9 to 15, wherein the feed gas stream prepared in (ii) comprises from 10 to 70 vol.-% of the one or more hydrocarbons, preferably from 12 to 60 vol.-%, more preferably from 15 to 50 vol.-%, more preferably from 20 to 40 vol.-%, more preferably from 22 to 29 vol.-%.

17. The process of any of embodiments 9 to 16, wherein the feed gas stream prepared in (ii) comprises from 0 to 75 vol.-% of H₂O, preferably from 0.5 to 70 vol.-%, more preferably from 1 to 68 vol.-%, more preferably from 3 to 66 vol.-%, more preferably from 5 to 64 vol.-%, more preferably from 8 to 62 vol.-%, more preferably from 10 to 60 vol.-%, more preferably from 25 to 50 vol.-%, more preferably from 33 to 44 vol.-%.

18. The process of any of embodiments 9 to 17, wherein the feed gas stream prepared in (ii) comprises from 0 to 60 vol.-% of CO₂, preferably from 1 to 58 vol.-%, more preferably from 3 to 56 vol.-%, more preferably from 5 to 54 vol.-%, more preferably from 8 to 52 vol.-%, more preferably from 10 to 50 vol.-%, more preferably from 12 to 20 vol.-%.

19. The process of any of embodiments 9 to 18, wherein the feed stream displays an H₂O: C molar ratio of H₂O to carbon contained in the one or more hydrocarbons in the range of from 0 to 4, preferably of from 0.1 to 3, more preferably of from 0.3 to 2.5, more preferably of from 0.4 to 2, and more preferably of from 0.5 to 1.6.

20. The process of embodiment 19, wherein the catalyst comprises Ni, and wherein the feed stream displays an H₂O:C molar ratio of H₂O to carbon contained in the one or more hydrocarbons in the range of from 0.6 to 3, preferably of from 0.7 to 2.5, more preferably of from 0.8 to 2, and more preferably of from 0.9 to 1.6.

21. The process of embodiment 19 or 20, wherein the catalyst comprises Co, and wherein the feed stream displays an H₂O:C molar ratio of H₂O to carbon contained in the one or more hydrocarbons in the range of from 0.2 to 2.5, preferably of from 0.3 to 2, more preferably of from 0.4 to 1.8, and more preferably of from 0.5 to 1.5.

22. The process of any of embodiments 9 to 21, wherein the feed stream displays a CO₂: C molar ratio of CO₂ to carbon contained in the one or more hydrocarbons in the range of from 0 to 4, preferably of from 0.1 to 3, more preferably of from 0.2 to 2, more preferably of from 0.3 to 1.5, more preferably of from 0.4 to 0.8.

23. The process of any of embodiments 9 to 22, wherein the feed stream displays an NH₃: C molar ratio of NH₃ to carbon contained in the one or more hydrocarbons in the range of from 0 to 5, preferably of from 0 to 4, more preferably of from 0.001 to 3, more preferably of from 0.005 to 2, and more preferably of from 0.01 to 1.

24. The process of any of embodiments 1 to 23, wherein the feed stream is fed into the reactor at a gas hourly space velocity in the range of from 500 to 16,000 h⁻¹, preferably of from 700 to 14,000 h⁻¹, more preferably of from 800 to 12,000 h⁻¹, more preferably of from 900 to 10,000 h⁻¹, more preferably of from 950 to 8,500 h⁻¹, and more preferably of from 1,000 to 8,000 h⁻¹.

25. The process of any of embodiments 9 to 24, wherein the effluent gas stream removed in (iv) further comprises CO₂.

26. The process of any of embodiments 9 to 25, wherein the effluent gas stream removed in (iv) displays a stoichiometry number R in the range of from 0.1 to 3, wherein R is defined according to formula (I):

$$R = \frac{c ( {H}_{2} ) - c ( {CO}_{2} )}{c ( {CO}_{2} ) + c ( CO )} , \qquad ( I )$$

wherein c (H₂), c (CO₂), and c (CO) stand for the molar concentration of H₂, CO₂, and CO in the effluent gas stream, respectively.

27. The process of embodiment 26, wherein the stoichiometry number R is in the range of from 1 to 2.5, preferably of from 1.3 to 2.2.

28. The process of embodiment 26, wherein R >2.

29. The process of any of embodiments 9 to 25 and 28, wherein the effluent gas stream removed in (iv) displays an H₂: CO molar ratio of >2.

30. The process of embodiment 26, wherein the stoichiometry number R is in the range of 0.5 to 3, preferably of from 1 to 2.2, and more preferably of 1.3 to 1.7.

31. The process of any of embodiments 9 to 30, wherein the effluent gas stream removed in (iv) comprises from 10 to 90 vol.-% of H₂, preferably from 20 to 80 vol.-%, more preferably from 30 to 70 vol.-%, more preferably from 40 to 65 vol.-%, and more preferably from 45 to 60 vol.-%.

32. The process of any of embodiments 9 to 31, wherein the effluent gas stream removed in (iv) comprises from 1 to 70 vol.-% of CO, preferably from 3 to 50 vol.-%, more preferably from 5 to 40 vol.-%, more preferably from 10 to 35 vol.-%, and more preferably from 15 to 30 vol.-%.

33. The process of any of embodiments 9 to 32, wherein the effluent gas stream removed in (iv) comprises from 1 to 50 vol.-% of CO₂, preferably from 3 to 45 vol.-%, more preferably from 5 to 40 vol.-%, more preferably from 8 to 35 vol.-%, more preferably from to 30 vol.-%, and more preferably from 12 to 25 vol.-%.

34. The process of any of embodiments 1 to 33, wherein the effluent gas stream removed in (iv) is employed in a process for the production of methanol, for the production of dimethyl ether, or for the production of methanol and dimethylether.

35. The process of any of embodiments 1 to 34, wherein the effluent gas stream removed in (iv) is employed in a process for the production of hydrocarbons, preferably accord-ing to the Fischer-Tropsch process.

36. The process of any of embodiments 1 to 35, wherein the effluent gas stream removed in (iv) is employed in a process for the production of alcohols, preferably of alkanols, more preferably of C1 to C10 alkanols, more preferably of C₂ to C₈ alkanols, more preferably of C₂ to C₆ alkanols, more preferably of C₂ to C₄ alkanols, more preferably of C2 alkanols, and more preferably of ethanol.

37. The process of any of embodiments 1 to 36, wherein after (i) and prior to (iii) the catalyst contained in the reactor provided in (i) is reduced in an atmosphere comprising hydrogen.

38. The process of embodiment 37, wherein the reduction is conducted at a temperature in the range of from 450 to 980° C., preferably of from 500 to 950° C., more preferably of from 600 to 920° C., more preferably of from 700 to 890° C., more preferably of from 750 to 870° C., and more preferably of from 800 to 850° C.

39. The process of embodiment 37 or 38, wherein the reduction is conducted in an atmos-phere comprising from 1 to 99 vol.-% H₂, preferably from 3 to 90 vol.-%, more preferably from 5 to 80 vol.-%, more preferably from 6 to 50 vol.-%, more preferably from 7 to vol.-%, more preferably from 8 to 20 vol.-%, and more preferably from 9 to 15 vol-%.

40. The process of any of embodiments 37 to 39, wherein the atmosphere comprises from 1 to 99 vol.-% of an inert gas, preferably of from 5 to 95 vol.-%, more preferably of from 10 to 90 vol.-%, more preferably from 30 to 70 vol.-%, and more preferably from to 55 vol.-%.

41. The process of embodiment 40, wherein the inert gas comprises one or more gases selected from the group consisting of noble gases and nitrogen gas, preferably from the group consisting of He, Ar, Ne, and N₂, wherein more preferably the inert gas comprises Ar, N₂, or Ar and N₂, wherein more preferably the inert gas comprises N₂, wherein more preferably the inert gas is N₂.

42. The process of any of embodiments 1 to 41, wherein at an initial stage of the process, the feed gas stream prepared in (ii) and fed into the reactor in (iii) further comprises H₂ for reducing the catalyst.

43. The process of embodiment 42, wherein the feed gas stream prepared in (ii) and fed into the reactor in (iii) further comprises from 2 to 80 vol.-% of H₂, preferably from 5 to 70 vol.-%, more preferably from 10 to 60 vol.-%, more preferably from 20 to 50 vol.-%, more preferably from 30 to 40 vol.-%.

44. The process of any of embodiments 1 to 43, wherein the catalyst contained in the re-actor provided in (i) further comprises a metal M2 selected from the group consisting of alkali metals, alkaline earth metals, Mo, Fe, and Ru, including mixtures of two or more thereof, preferably from the group consisting of Li, K, Na, Cs, Mg, Ca, Sr, Ba, Mo, Fe, and Ru, including mixtures of two or more thereof, more preferably from the group consisting of K, Na, Cs, Ba, Mo, Fe, and Ru, including mixtures of two or more thereof, more preferably from the group consisting of K, Ba, Mo, Fe, and Ru, including mixtures of two or more thereof, more preferably from the group consisting of Fe, Ru, or Fe and Ru, wherein preferably M2 comprises Ru, wherein more preferably M2 is Ru.

45. The process of any of embodiments 1 to 44, wherein the catalyst contained in the re-actor provided in (i) further comprises one or more support materials onto which the metal M1 or the metals M1 and M2 are supported, wherein the one or more support materials are preferably selected from the group consisting of Al₂O₃, SiO₂, ZrO₂, CeO₂, MgO, CaO, and mixtures of two or more thereof, more preferably from the group con-sisting of Al₂O₃, SiO₂, ZrO₂, CeO₂, and mixtures of two or more thereof, more preferably from the group consisting of Al₂O₃, SiO₂, and mixtures thereof, wherein more preferably the support material comprises Al₂O₃.

46. The process of embodiment 44 or 45, wherein the catalyst contained in the reactor provided in (i) displays an M2: M1 atomic ratio in the range of from 0.1:99.9 to 80:20, preferably of from 0.5:99.5 to 75:25, more preferably of from 1:99 to 70:30, more preferably of from 5:95 to 65:35, more preferably of from 15:85 to 60:40, more preferably of from 30:70 to 55:45, and more preferably of from 40:60 to 50:50.

47. The process of embodiment 46, wherein M2 comprises, preferably is, Fe, and wherein the catalyst displays an M2: M1 atomic ratio in the range of from 1:99 to 80:20, preferably of from 5:95 to 75:25, more preferably of from 10:90 to 70:30, more preferably of from 20:80 to 65:35, more preferably of from 30:70 to 60:40, more preferably of from 35:65 to 55:45, and more preferably of from 40:60 to 50:50.

48. The process of embodiment 46 or 47, wherein M2 comprises, preferably is, Ru, and wherein the catalyst displays an M2: M1 atomic ratio in the range of from 0.1:99.9 to 30:70, preferably of from 0.5:99.5 to 30:70, more preferably of from 1:99 to 20:80, more preferably of from 3:97 to 10:90, and more preferably of from 5:95 to 6:94.

49. The process of any of embodiments 1 to 48, wherein the catalyst contained in the re-actor provided in (i) further comprises Al and O.

50. The process of embodiment 49, wherein the catalyst contained in the reactor provided in (i) comprises Ni as the metal M1, wherein preferably the metal M1 is Ni.

51. The process of embodiment 50, wherein the catalyst further comprises Mg, wherein the Ni: Mg: Al molar ratio is preferably in the range of from 1:(0.1-12):(0.5-20), more preferably of from 1:(0.5-8):(1-12), more preferably of from 1:(1-5):(3-8), more preferably of from 1:(1.5-3):(3.5-5), and more preferably of from 1:(2.0-2.4):(4.0-4.4).

52. The process of embodiment 50 or 51, wherein from 95 to 100 wt.-% of the catalyst consists of Ni, Mg, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

53. The process of embodiment 50 or 51, wherein from 95 to 100 wt.-% of the catalyst consists of M2, Ni, Mg, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

54. The process of embodiment 49, wherein the catalyst contained in the reactor provided in (i) comprises Co as the metal M1, wherein preferably the metal M1 is Co.

55. The process of embodiment 54, wherein the catalyst further comprises La, wherein the Co: La: Al molar ratio is preferably in the range of from 1:(0.1-8):(1-50), more preferably of from 1:(0.5-5):(3-30), more preferably of from 1:(0.8-3):(5-20), more preferably of from 1:(1-2):(8-15), and more preferably of from 1:(1.3-1.7):(10-12).

56. The process of embodiment 54 or 55, wherein from 95 to 100 wt.-% of the catalyst consists of Co, La, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

57. The process of embodiment 54 or 55, wherein from 95 to 100 wt.-% of the catalyst consists of M2, Co, La, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

58. The process of any one of embodiments 1 or 57, wherein the catalyst contained in the reactor provided in (i) is in form of a molding.

59. The process of embodiment 58, wherein the molding is a tablet.

60. The process of embodiment 59, wherein the tablet has a four-hole cross-section, preferably a four-hole cross-section having a diameter in the range of from 12 to 19 mm, more preferably in the range of from 16 to 18 mm, more preferably in the range of from 16.7 to 16.8 mm, and a height in the range of from 7 to 11 mm, more preferably in the range of from 9.5 to 10.5 mm, more preferably in the range of from 9.7 to 10.0 mm.

61. The process of embodiment 60, wherein the tablet is a calcined tablet, wherein the calcination has preferably been performed in a gas atmosphere having a temperature in the range of from 350 to 450° C., more preferably in the range of from 360 to 440° C., more preferably in the range of from 375 to 425° C., more preferably in the range of from 390 to 410° C., wherein the gas atmosphere more preferably comprised oxygen, more preferably was one or more of oxygen, air, or lean air, wherein the cal-cining was performed more preferably for 0.5 to 20, more preferably for 1 to 15 h, more preferably for 2 to 10 h, more preferably for 3 to 5 h.

62. The process of embodiment 60 or 61, wherein the tablet has a side crushing strength 1 (SCS1) of at least 70 N, preferably in the range of from 70 to 250 N, more preferably in the range of from 70 to 130 N, determined as described in Reference Example 2, wherein four cylindrical segments are located in an area each between two flutes, wherein the side crushing strength 1 is measured according to Reference Example 2 in a condition where the tablet stands on two cylindrical segments sided by a flute.

63. The process of any one of embodiments 60 to 62, wherein the tablet has a side crushing strength 2 (SCS2) of at least 60 N, preferably in the range of from 60 to 200 N, more preferably in the range of from 60 to 88 N, determined as described in Reference Example 2, wherein four cylindrical segments are located in an area each between two flutes, wherein the side crushing strength 2 is measured according to Reference Example 2 in a condition where the tablet stands on a cylindrical segment.

64. The process of any one of embodiments 60 to 63, wherein the tablet has a side crushing strength 3 (SCS3) of at least 190 N, preferably in the range of from 190 to 350 N, more preferably in the range of from 190 to 240 N, determined as described in Reference Example 2, wherein four cylindrical segments are located in an area each between two flutes, wherein the side crushing strength 3 is measured according to Reference Example 2 in a condition where the area of the cylindrical segments is perpendicular to the direction of the force applied on the tablet.

65. The process of embodiment 59, wherein the tablet has a four-hole cross-section, preferably a four-hole cross-section having a diameter in the range of from 10 to 18 mm, more preferably in the range of from 13.5 to 16.0 mm, more preferably in the range of from 14.0 to 15.5 mm, and a height in the range of from 5 to 11 mm, more preferably in the range of from 7.5 to 9.4 mm, more preferably in the range of from 8.2 to 9.0 mm.

66. The process of embodiment 65, wherein the tablet is a calcined tablet, wherein the calcination has preferably been performed in a gas atmosphere having a temperature in the range of from 800 to 1400° C., more preferably in the range of from 875 to 1275° C., more preferably in the range of from 950 to 1250° C., more preferably in the range of from 1050 to 1225° C., wherein the gas atmosphere more preferably comprised oxygen, more preferably was one or more of oxygen, air, or lean air, wherein the calcining was performed more preferably for 0.5 to 20 h, more preferably for 1 to 15 h, more preferably for 2 to 10 h, more preferably for 3 to 5 h.

67. The process of embodiment 65 or 66, wherein the tablet has a side crushing strength 1 (SCS1) of at least 366 N, preferably of at least 400 N, more preferably in the range of from 400 to 800 N, more preferably in the range of from 400 to 600 N, more preferably in the range of from 400 to 570 N, determined as described in Reference Example 1, the molding more preferably being a tablet having a four-hole cross-section and having four flutes, wherein four cylindrical segments are located in an area each between two flutes, wherein the side crushing strength 1 is measured according to Reference Example 1 in a condition where the tablet stands on two cylindrical segments sided by a flute.

68. The process of any one of embodiments 65 to 67, wherein the tablet has a side crushing strength 2 (SCS2) of at least 170 N, preferably of at least 190 N, more preferably in the range of from 190 to 450 N, more preferably in the range of from 190 to 300 N, more preferably in the range of from 190 to 270 N, determined as described in Reference Example 1, wherein four cylindrical segments are located in an area each between two flutes, wherein the side crushing strength 2 is measured according to Reference Example 1 in a condition where the tablet stands on a cylindrical segment.

69. The process of any one of embodiments 65 to 68, wherein the tablet has a side crushing strength 3 (SCS3) of at least 345 N, preferably of at least 500 N, more preferably in the range of from 500 to 950 N, more preferably in the range of from 500 to 800 N, more preferably in the range of from 500 to 770 N, determined as described in Reference Example 1, wherein four cylindrical segments are located in an area each between two flutes, wherein the side crushing strength 3 is preferably measured accord-ing to Reference Example 1 in a condition where the area of the cylindrical segments is perpendicular to the direction of the force applied on the tablet.

### DESCRIPTION OF THE FIGURES

FIG. 1 displays the results of NH₃-reforming from Example 4 employing the Ni-based catalyst of Example 1 at 30 bar and GHSV of 8000 h⁻¹ including 5000 ppmv H₂O in the NH₃ feed. In the figure, the conversion of ammonia in % is plotted along the ordinate and the temperature in° C. is plotted along the abscissa. The measured conversion rates are indicated as medium grey circles, wherein the equilibrium conversion rate at that temperature is indicated as dark grey squares.

FIG. 2 displays the results of NH₃-reforming from Example 4 employing the Co-based catalyst of Example 2 at 30 bar and GHSV of 8000 h⁻¹ including 5000 ppmv H₂O in the NH₃ feed. In the figure, the conversion of ammonia in % is plotted along the ordinate and the temperature in° C. is plotted along the abscissa. The measured conversion rates are indicated as medium grey circles, wherein the equilibrium conversion rate at that temperature is indicated as dark grey squares.

FIG. 3 displays the results of NH₃-reforming from Example 4 employing the Ni-based catalysts with PGM and transition metal promotion at GHSV of 2000⁻¹, 30 bar and 10000 ppmv of H₂O in the NH₃ feed.

FIG. 4: shows on the left the side view for the arrangement for determining side crushing strength 1 (SCS1), in the middle the side view for the arrangement for determining side crushing strength 2 (SCS2), and on the right the side view for the arrangement for determining side crushing strength 3 (SCS3).

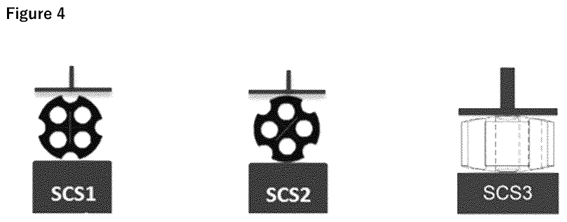

### EXPERIMENTAL SECTION

The present invention is further illustrated by the following examples.

### Reference Example 1: Determination of the Side Crushing Strength

The side crushing strength was determined on a semi-automatic tablet testing system So-taxST-50 WTDH. The side crushing strength was measured with a constant speed of 0.05 mm/s. A range of from 0 to 800 N could be tested. For each measurement, the orientation of the sample was adjusted with a horizontal rotating table and fine adjustment has been made manually. Further, several measurement parameters were adjusted—if applica-ble—depending on the orientation and properties of the sample, such as the mass, the height/thickness, the diameter and strength at rupture. The gained data were evaluated with the scientific program q-doc prolab (version 4fsp2 (4.10)). Tablets having a four-hole cross-section were tested, whereby three positions being perpendicular to each other were probed allowing determination of the side crushing strength 1, side crushing strength 2 and side crushing strength 3. The relative standard deviation for crushing strength 1, 2, and 3 was 7.48%.

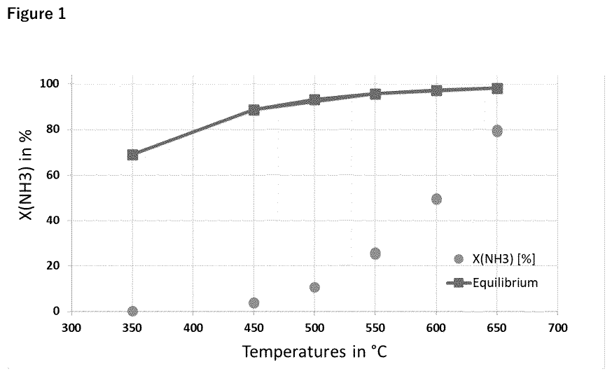

As can be seen in FIG. 1, side crushing strength 1 refers to a position of the tablet in the semi-automatic tablet testing system where the sample stands on two cylindrical segments sided by a flute on the rotating table, side crushing strength 2 refers to a position where the sample stands on one cylindrical segment on the rotating table, and side crushing strength 3 refers to a position where the holes are in parallel to the direction of the force applied on the sample during the test.

### Reference Example 2: Determination of the Side Crushing Strength

The side crushing strength was determined on a tablet testing system (Typ BZ2.5/TS1S, Zwick). The side crushing strength was measured using a punching tool. The side crushing strength was recorded as soon as the sample broke. For each measurement, the orientation of the sample was adjusted manually on a horizontal table. The punching tool was arranged to punch from above. Further, several measurement parameters were adjusted-if applica-ble-depending on the orientation and properties of the sample, such as the mass, the height/thickness, the diameter and strength at rupture. Tablets having a four-hole cross-section were tested, whereby three positions being perpendicular to each other were probed allowing determination of the side crushing strength 1, side crushing strength 2 and side crushing strength 3. As can be seen in FIG. 1, side crushing strength 1 refers to a position of the tablet in the semi-automatic tablet testing system where the sample stands on two cylindrical segments sided by a flute on the rotating table, side crushing strength 2 refers to a position where the sample stands on one cylindrical segment on the rotating table, and side crushing strength 3 refers to a position where the holes are in parallel to the direction of the force applied on the sample during the test.

### Example 1: Preparation of a Catalyst Comprising Ni

The catalyst comprising Ni was prepared following the process described in example E1 of WO 2013/068905 A1.

An aqueous solution of Nickel nitrate (14% Ni concentration) was used instead of the pul-verulent nickel nitrate hexahydrate. The various ingredients were mixed to a paste which was extruded. The extrudates were crushed and sieved to a target fraction having a particle size of from 200 to 900 μm after drying and low temperature calcination.

The sieved powder was then mixed with graphite 2.8 weight.-% (Asbury Graphite 3160) and 5.5 weight-% cellulose (Arbocel BWW 40). The resulting mixture was tableted to moldings having a four-hole cross-section as shown in FIG. 1 of WO 2020/157202 A. For calcination, the moldings were heated in an annealing furnace to a temperature of 1,030 to 1,050° C. which was held for 4 hours.

The nickel content of the calcined moldings was 15.5 weight-%, the magnesium content 14.0 weight-%, the aluminium content was 29.5 weight-%.

### Example 2: Preparation of a Catalyst Comprising Co

The catalyst comprising Co was prepared according Example 1 of WO 2020/157202 A1.

### Example 3: Preparation of Ni-Based Catalyst Including PGM or Transition Metal ProMotion

The catalysts comprising Ni and platinum group metal or transition metal promotion were prepared following the process described in example E1 of WO 2013/068905 A1. A part of the Ni-salt was substituted by an Fe-salt (here: Fe(NO₃)₃ (H₂O)₉, degree of substitution 40 at.-% based on the Ni-content). Alternatively, a part of the Ni-salt (here: Ni-nitrate) was substituted by a Ru-salt (here Ru(NO)(NO₃)₃ solution, 19,7% Ru conc., degree of substitution 5 at. % based on the Ni-content). The respective metal salt mixtures were mixed with the hydrotalcite and suitable amounts of water to prepare an extrudable paste. This paste was extruded in the next step. The subsequent heat treatments of the resulting extrudates were identical to example 1 (example E1 of WO2013/068905 A1).

The procedures accordingly afforded a Ni+Fe supported catalyst and a Ni+Ru supported catalyst, respectively.

### Example 4: Catalytic Tests in NH₃-Reforming Under High Pressure

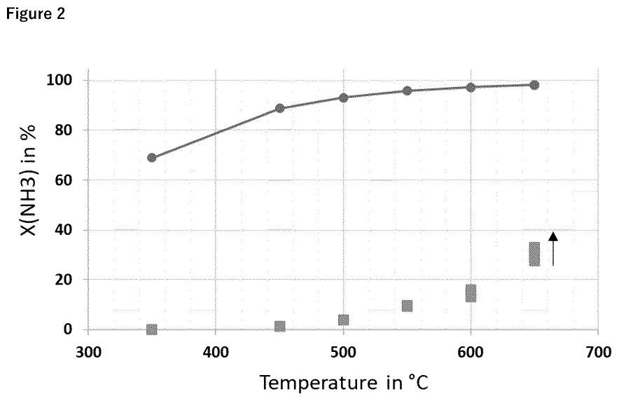

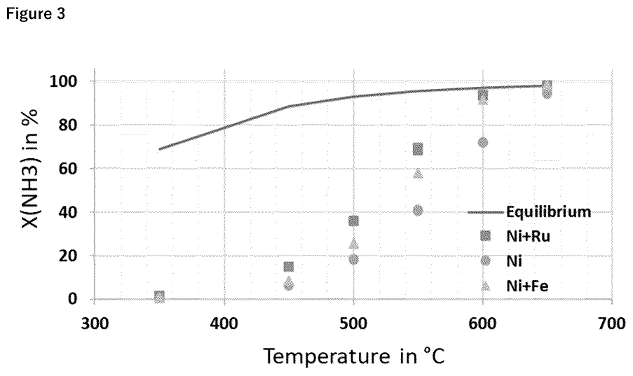

The catalysts obtained according to Examples 1-3 were reduced under a mixture of an increasing concentration (with increasing temperature) of 5-50 vol.-% H₂ in inert gas (Ar or N₂) at temperatures of 450-650° C. for the Ni-catalysts and of 450-850° C. for the Co-catalyst. The catalytic NH₃-reforming tests were conducted under p (NH₃) of 30 bar. To the NH₃ feed, a fraction of 5000-10,000 ppmv of H₂O is added. Further, the catalysts were tested at GHSV of 2,000 and 8,000 h⁻¹ and temperatures of 350-650° C. The conversion of NH₃ as function of the temperature at the corresponding GHSVs at 30 bar are shown in Table 1. Furthermore, the results for the samples of Examples 1 and 2 at a GHSV of 8,000 h⁻¹ including 5,000 ppmv H₂O visualized in FIGS. 1 and 2, and the results of the samples of Examples 1 and 3 at a GHSV of 2,000 h⁻¹ including 10,000 ppmv H₂O are displayed in FIG. 3.

TABLE 1
Conversion results of the catalysts according to Examples
1-3 under high pressure reforming of NH₃.

| | | Ex. 3 | Ex. 1 | Ex. 3 | Ex. 1 | Ex. 2 |
|---|---|---|---|---|---|---|
| | | (Ni + Ru) | (Ni) | (Ni + Fe) | (Ni) | (Co) |
| | | 10,000 ppmv H₂O | | | 5,000 ppmv H₂O | |
| Temp | p(NH₃) | GHSV = 2,000 h − 1 | | | GHSV = 8,000 h − 1 | |
| 350 | 30 | 1.50 | 0.50 | 0.60 | 0.28 | 0.08 |
| 450 | 30 | 15.03 | 6.41 | 8.65 | 3.66 | 1.30 |
| 500 | 30 | 36.27 | 18.40 | 25.80 | 10.53 | 3.76 |
| 550 | 30 | 68.44 | 40.65 | 58.07 | 25.18 | 9.37 |
| 600 | 30 | 93.43 | 71.78 | 91.48 | 49.42 | 13.00 |
| 650 | 30 | 98.30 | 94.52 | 98.44 | 79.42 | 32.88 |

As may be taken from the catalyst testing results indicated in Table 1 and displayed in FIG. 1, the ammonia reforming reaction conducted with the Ni-catalyst from Example 1 achieves increasing conversion rates with increasing temperature, wherein at 650° C., the conversion rate almost achieves the equilibrium conversion rate at that temperature. In FIG. 2, the results obtained from ammonia reforming using the Co-catalyst from Example 2 are displayed. Again, growing conversion rates are achieved with increasing temperature, although the conversion rate at 650° C. is not nearly as high as the conversion rate obtained when employing the Ni-catalyst as shown in FIG. 1.

Finally, the results from catalyst testing of the Ni-catalyst from Examples 1 and 3 which were conducted at lower GHSV and with higher amounts of steam are displayed in FIG. 3. As may be taken from the results, under those conditions, the Ni-catalyst from Example 1 achieves almost equilibrium conversion at 650° C. Furthermore, when promoted with Ru or Fe, the ammonia conversion rate increases more rapidly, and the conversion rates for the promoted catalysts achieves almost equilibrium conversion rates already at 600° C. for the achieving a conversion rate of over 98% at 650° C.

### Example 5: Simulation of the Combined Reforming of NH₃ and Hydrocarbons with or without CO₂

Due to the high activity of the catalysts at the corresponding conditions (20 bar, high temperatures), catalytic performance at the equilibrium conditions is expected when residence times are selected accordingly. For investigating this, simulations were conducted using the software Aspen Plus V11. Tables 2 and 3 shows the inlet and outlet concentration for various cases of the combined reforming of NH₃ and, e.g. hydrocarbons (here: CH)/CO₂ under dry conditions. As may be seen from the results in Tables 2 and 3, the incremental increase of the NH, as co-feed leads to an increase of the R-value due to the additional H₂ created by the NH₃-reforming.

TABLE 2
Inlet concentrations used for the simulations in Example 5.

| | | | H₂O | CO₂ | CH₄ | NH₃ |
|---|---|---|---|---|---|---|
| 20 bar | CO₂/C | S/C | [vol.-%] | [vol.-%] | [vol.-%] | [vol.-%] |
| Simulation 1 | 0.43 | 2.5 | 63.64 | 10.91 | 25.45 | 0 |
| Simulation 2 | 0.43 | 1.5 | 51.22 | 14.63 | 34.15 | 0.00 |
| Simulation 3 | 0.43 | 1.5 | 48.78 | 13.94 | 32.52 | 4.76 |
| Simulation 4 | 0.43 | 1.5 | 46.14 | 13.18 | 30.76 | 9.91 |
| Simulation 5 | 0.43 | 1.0 | 41.18 | 17.65 | 41.18 | 0.00 |
| Simulation 6 | 0.43 | 1.0 | 37.43 | 16.04 | 37.43 | 9.09 |
| Simulation 7 | 0.43 | 1.0 | 35.81 | 15.35 | 35.81 | 13.04 |

TABLE 3
Simulations of the outlet concentrations in Example 5 based on thermodynamic
limitations and calculation of the corresponding R-values.

| | T | CO | CO₂ | H₂ | H₂O | CH₄ | NH₃ | N₂ | |
|---|---|---|---|---|---|---|---|---|---|
| 20 bar | [° C] | [vol.-%] | [vol.-%] | [vol.-%] | [vol.-%] | [vol.-%] | [vol.-%] | [vol.-%] | R |
| Sim. 1 | 850 | 13.93 | 8.46 | 44.83 | 29.49 | 3.28 | 0 | 0 | 1.62 |
| | 900 | 15.84 | 7.40 | 47.26 | 27.85 | 1.65 | 0 | 0 | 1.71 |
| | 950 | 17.08 | 6.63 | 48.38 | 27.16 | 0.75 | 0 | 0 | 1.76 |
| Sim. 2 | 850 | 18.49 | 7.61 | 46.37 | 20.67 | 6.86 | 0 | 0 | 1.49 |
| | 900 | 21.18 | 6.11 | 50.38 | 18.30 | 4.04 | 0 | 0 | 1.62 |
| | 950 | 23.03 | 5.04 | 53.00 | 16.77 | 2.16 | 0 | 0 | 1.71 |
| Sim. 3 | 850 | 17.36 | 6.89 | 47.05 | 20.21 | 6.88 | 0.023 | 1.58 | 1.66 |
| | 900 | 19.98 | 5.53 | 51.08 | 17.80 | 4.09 | 0.020 | 1.51 | 1.79 |
| | 950 | 21.81 | 4.56 | 53.74 | 16.22 | 2.21 | 0.017 | 1.46 | 1.87 |
| Sim. 4 | 850 | 16.14 | 6.14 | 47.82 | 19.70 | 6.89 | 0.034 | 3.27 | 1.87 |
| | 900 | 18.69 | 4.93 | 51.86 | 17.24 | 4.13 | 0.029 | 3.12 | 1.99 |
| | 950 | 20.48 | 4.06 | 54.56 | 15.61 | 2.25 | 0.024 | 3.01 | 2.06 |
| Sim. 5 | 850 | 21.80 | 6.77 | 45.69 | 15.34 | 10.41 | 0.000 | 0.00 | 1.36 |
| | 900 | 24.83 | 5.00 | 50.52 | 12.82 | 6.82 | 0.000 | 0.00 | 1.53 |
| | 950 | 27.02 | 3.76 | 54.17 | 10.89 | 4.16 | 0.000 | 0.00 | 1.64 |
| Sim. 6 | 850 | 19.16 | 5.66 | 47.00 | 15.02 | 10.17 | 0.031 | 2.96 | 1.67 |
| | 900 | 22.06 | 4.20 | 51.77 | 12.42 | 6.73 | 0.027 | 2.79 | 1.81 |
| | 950 | 24.18 | 3.16 | 55.38 | 10.44 | 4.15 | 0.023 | 2.66 | 1.91 |
| Sim. 7 | 850 | 18.03 | 5.20 | 47.61 | 14.85 | 10.06 | 0.038 | 4.22 | 1.83 |
| | 900 | 20.86 | 3.87 | 52.34 | 12.23 | 6.68 | 0.033 | 3.99 | 1.96 |
| | 950 | 22.95 | 2.91 | 55.92 | 10.23 | 4.14 | 0.028 | 3.81 | 2.05 |

The results from the simulation displayed in Tables 2 and 3 thus demonstrate the concept of the combined reforming approach (NH₃+HC+CO₂+H₂O) in manipulating and steering the R-value of a final syngas composition. The increase of the R number can possibly start at 0.1 (from a combined reforming including very-dry conditions of reforming, less H₂O and more CO₂/HC) to reach, e.g., R values between 1 and 1.5 for Fischer-Tropsch-like reactions or one-step DME. But also a syngas with an R number >2 is possible.

The same holds for the combined reforming of NH₃ and HC/CO₂ under dry conditions, possibly starting at R values of 0.5 to finally reach a R >2 upon increasing the NH₃ amount. So, basically any R-value between 0.1-2.5 is possibly adjusted by the amount of NH₃ co-dosing to the HC/CO₂/H₂O gas mixture.

### Example 6: Catalytic Testing

Catalytic tests were performed on a single reactor test unit. This unit allowed for test conditions in a broad temperature and pressure range up to 1100° C. and 20 bar (gauge). As gas feeds carbon dioxide (also designated as CO₂-in), methane (also designated CH₄-in), nitrogen (also designated as N₂-in), ammonia (also designated as NH₃-in) and argon (also designated as Ar-in) were provided and online controlled by mass flow controllers (MFCs). Water (also designated as H₂O-in) was added as steam to the feed stream by an evaporator con-nected to a water reservoir. Analysis of the product gas composition was carried out by online-gas chromatography using argon as internal standard. Gas chromatographic analyt-ics allowed the quantification of hydrogen, carbon monoxide, carbon dioxide, methane, ammonia, nitrogen and C2 components. For the catalytic test, the catalytic material was split (0.5 to 1.0 mm) and 15 ml of the split were then tested as a catalyst. As catalyst, a mixed metal oxide comprising Ni and Mg according to example E1 of WO 2013/068905 A1 was used. The sample was placed in the isothermal zone of the reactor using a ceramic fitting. The given temperature describes the temperature of the oven.

The results of the catalytic testing are described in following table. Phase 1+2 and 3+4 rep-resent different kinds of biogas without and with, respectively, NH₃ co-feeding for the adjustment of the R-value.

TABLE 4
Results of the catalytic testing. In each phase the pressure was adjusted to 20 bar (gauge).

| Phase | T | GHSV | CH₄-in | CO₂-in | H₂O-in | NH₃-in | Ar-in | N₂-in | R |
|---|---|---|---|---|---|---|---|---|---|
| [#] | [° C] | [h⁻¹] | [mol.-%] | [mol.-%] | [mol.-%] | [mol.-%] | [mol.-%] | [mol.-%] | value |
| 1 | 950 | 8000 | 28.5 | 14.1 | 43.1 | 0 | 5 | 9.3 | 1.5 |
| 2 | 950 | 8000 | 28.5 | 14.1 | 43.1 | 13.5 | 0.8 | 0 | 2.1 |
| 3 | 950 | 6000 | 23.0 | 17.0 | 34.0 | 0 | 3 | 23 | 0.95 |
| 4 | 950 | 6000 | 23.0 | 17.0 | 34.0 | 23.0 | 3 | 0 | 1.95 |

GHSV: gas hourly space velocity

As can be seen from the results shown in table 4, the process according to the present invention, wherein a Ni and/or Co containing catalyst is used, allows reforming of ammonia for providing a syngas stream, especially in a combined reforming approach of NH₃ and hydrocarbons. In particular, a synthesis gas can be produced which matches the R-value of a corresponding down-stream application (e.g. MeOH production, DME production or Fischer-Tropsch process).

### Cited Prior Art

WO 2013/068905 A
WO 2013/118078 A
WO 2020/157202 A1
Int. J. of Hydr. and Energ., 2020, 45, 8965-8974
Int. J. of Hydr. and Energ., 2014, 39, 35, 19990-19999
Top Catal (2016) 59:1438-1457
WO 2021/175785 A1
Catal. Sci. Technol., 2020, 10, 5027-5035

1.-15. (canceled)

16. A process for the reforming of ammonia, wherein the process comprises
(i) providing a reactor containing a catalyst comprising a metal M1 selected from the group consisting of Ni, Co, or Ni and Co;
(ii) preparing a feed gas stream comprising NH₃;
(iii) feeding the feed gas stream prepared in (ii) into the reactor provided in (i) and contacting the feed gas stream with the catalyst, wherein contacting is performed at a pressure of 1 to 50 bara, and at a temperature of 400 to 1,100° C.;
(iv) removing an effluent gas stream from the reactor, the effluent gas stream comprising H₂ and N₂.

17. The process of claim 16, wherein the feed gas stream prepared in (ii) comprises from 200 to 20,000 ppmv of H₂O.

18. The process of claim 16, wherein the total amount of NH₃, N₂, and H₂ comprised in the feed gas stream prepared in (ii) is in the range from 90 to 100 wt.-%.

19. The process of claim 16, wherein the process is for the reforming of ammonia and hydrocarbons, wherein the feed gas stream prepared in (ii) further comprises one or more hydrocarbons, and one or more of CO₂ and H₂O, and wherein the effluent gas stream removed in (iv) further comprises CO.

20. The process of claim 19, wherein the feed gas stream prepared in (ii) further comprises CO₂, H₂O, and one or more hydrocarbons.

21. The process of claim 19, wherein the one or more hydrocarbons are selected from the group consisting of alkanes and mixtures thereof.

22. The process of claim 19, wherein contacting is performed at a pressure in the range of from 10 to 50 bara.

23. The process of claim 19, wherein the feed gas stream prepared in (ii) comprises from 0.1 to 75 vol.-% of NH₃.

24. The process of claim 19, wherein the feed gas stream prepared in (ii) comprises from 10 to 70 vol.-% of the one or more hydrocarbons.

25. The process of claim 16, wherein the feed stream is fed into the reactor at a gas hourly space velocity in the range of from 500 to 16,000 h⁻¹.

26. The process of claim 19, wherein the effluent gas stream removed in (iv) displays a stoichiometry number R in the range of from 0.1 to 3, wherein R is defined according to formula (I):
$$R = \frac{c ( {H}_{2} ) - c ( {CO}_{2} )}{c ( {CO}_{2} ) + c ( CO )} , \qquad ( I )$$
wherein c (H₂), c (CO₂), and c (CO) stand for the molar concentration of H₂, CO₂, and CO in the effluent gas stream, respectively.

27. The process of claim 26, wherein the stoichiometry number R is in the range of 0.5 to 3.

28. The process of claim 16, wherein the catalyst contained in the reactor provided in (i) further comprises Al and O.

29. The process of claim 28, wherein the catalyst contained in the reactor provided in (i) comprises Ni as the metal M1, wherein the catalyst further comprises Mg.

30. The process of claim 28, wherein the catalyst contained in the reactor provided in (i) comprises Co as the metal M1, wherein the catalyst further comprises La.
